(19) United States
(12) Patent Application Publication
(10) Pub. No.: US 2013/0239385 A1
(43) Pub. Date: Sep. 19, 2013

(54) PRECISION ALIGNMENT DEVICE OF AN OPTICAL COMPONENT AND A METHOD OF USING THE DEVICE

(71) Applicant: KOREA ASTRONOMY AND SPACE SCIENCE INSTITUTE, Daejeon (KR)

(72) Inventor: Chan PARK, Daejeon (KR)

(73) Assignee: Korea Astronomy and Space Science Institute, Daejeon (KR)

(21) Appl. No.: 13/847,017

(22) Filed: Mar. 19, 2013

(30) Foreign Application Priority Data
Mar. 19, 2012 (KR) 10-2012-0027659

(51) Int. Cl. G02B 7/00

(52) U.S. Cl. CPC G02B 7/003
USPC 29/426.2; 403/299

(57) ABSTRACT

Provided are a precision alignment device of an optical component and a method of using the device. The device includes a location fixing unit inserted and coupled to a pin hole on an optical table, closely attached to an optical mount, and fixes a location of the optical component, and a bumper including a penetration hole formed to allow the location fixing unit to penetrate to be coupled thereto, the bumper having a thickness formed in a lateral direction to maintain a certain distance between the location fixing unit and the optical mount when at least one side is closely attached to the optical mount. A location of the optical mount is determined while coupling the bumper to the location fixing unit.

### CROSS-REFERENCE TO RELATED PATENT APPLICATION

This application claims the benefit of Korean Patent Application No. 10-2012-0027659, filed on Mar. 19, 2012, in the Korean Intellectual Property Office, the disclosure of which is incorporated herein in its entirety by reference.

### BACKGROUND OF THE INVENTION

1. Field of the Invention

The present invention relates to a precision alignment device of an optical component and a method of precisely aligning optical components by using the device, and more particularly, to a device for precisely aligning a location of an optical component on an optical bench and a method of precisely aligning an optical component by using the device.

2. Description of the Related Art

Optical systems include mirrors, lenses, and prisms to form images of objects via reflection, refraction, or transmission of light. An optical apparatus is composed of the assembly of the optical systems to meet their own purposes and alignment tolerances.

When assembling such an optical apparatus, it should be accurate and precise enough to align all of the optical components including mirrors, lenses, and dispersive elements. Otherwise, aberrations or optical path differences may occur in such a way that it is difficult to obtain definite images of objects and it is lack of reliability to the measured quantities.

Accordingly, a traditional way of the precision alignment is to use a micrometer installed at the optical component to be precisely aligned. The micrometer with an accurate pitch precision screw can be driven manually or electrically to perform micro alignment.

FIG. 1 is a view illustrating a stage on which a typical micrometer for precisely aligning optical components.

In general, a micrometer with a knob is installed on a stage where optical components should be installed to precisely align locations of optical components with hands as shown in FIG. 1A, and the micrometer is controlled by a driving unit such as a servomotor to precisely align locations of optical components using electricity as shown in FIG. 1B.

However, it needs a large space to precisely align locations of optical components by using the typical micrometer.

Particularly, when thermal noises such as infrared radiation may occur, to prevent thermal noises, an optical apparatus is configured to operate in a vacuum container at an extremely low temperature. In this case, the optical apparatus is generally designed to be very compact to minimize the “cold mass” of a cryogenic system in an instrument so that there is not sufficient room for installing the micrometer as described above.

In addition, as a driving unit for controlling the micrometer, a vacuum motor for extremely low temperature environment is to be additionally mounted, or a feedthrough with a rotating knob penetrating a wall of the vacuum vessel needs to be prepared for manual adjustment. It causes not only additional cost but also increase of the chance of malfunction after using for a certain period of time.

Accordingly, for optical devices, particularly, for the case of cryogenic vacuum vessel where there is not enough space for precision alignment of optical elements, there is urgent need for the technology to precisely align each optical component of a cryogenic instrument system.

### SUMMARY OF THE INVENTION

The present invention provides a precision alignment device of an optical component, the device being capable of precisely aligning respective optical components of an optical apparatus in a small space, and a method of precisely aligning an optical component by using the precision alignment device of an optical component.

According to an aspect of the present invention, a precision alignment device of an optical component includes a location fixing unit inserted and coupled to a pin hole on an optical table, closely attached to an optical mount, and fixes a location of the optical component and a bumper including a penetration hole formed to allow the location fixing unit to penetrate to be coupled thereto, the bumper having a thickness formed in a lateral direction to maintain a certain distance between the location fixing unit and the optical mount when at least one side is closely attached to the optical mount. In this case, a location of the optical mount is determined while coupling the bumper with the location fixing unit.

The location fixing unit may include a non-screw portion where there is not formed a screw thread, and the bumper may be coupled to the non-screw portion and determine the location of the optical mount.

The bumper may include an opening formed on one side thereof from the one side to the penetration hole to allow the location fixing unit to be inserted and coupled thereto.

The bumper may further include a flat portion on the one side formed by extending the opening in a certain direction.

The bumper may include a curved portion formed roundly with a certain curvature on one side.

The device may further include a washer located between a head portion of the location fixing unit and the bumper, the washer with a penetration hole to allow the location fixing unit to penetrate the same.

According to another aspect of the present invention, a method of precisely aligning an optical component by using the precision alignment device of an optical component includes transferring an optical mount to be closely attached to the device inserted and coupled to a pin hole of an optical table to be initially arranged, separating a bumper having a thickness in a lateral direction, from a location fixing unit, and coupling another bumper having a thickness different from that of the bumper having a thickness in a lateral direction, to the location fixing unit.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are views illustrating stages on which typical micrometers for precisely aligning optical components is mounted;

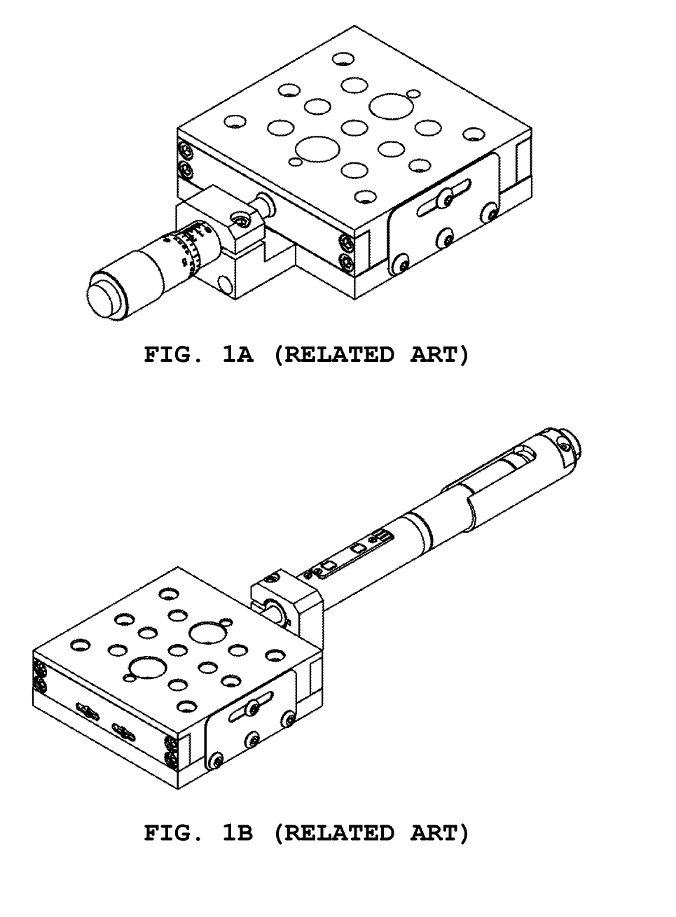

FIG. 2A is a perspective view illustrating an aspherical mirror is installed on an optical table according to an embodiment of the present invention;

FIG. 2B is an enlarged view illustrating a part of the mirror in FIG. 2A;

FIG. 3A is a perspective view illustrating a precision alignment device of an optical component according to an embodiment of the present invention;

FIG. 3B is a perspective view illustrating a location fixing unit and a bumper that are components of the precision alignment device of an optical component of FIG. 3A;

FIG. 3C is a top view illustrating the bumper according to the present embodiment;

FIGS. 4A and 4B are top views illustrating an example of aligning a location of an optical mount by using the precision alignment device of an optical component according to the present embodiment; and

FIG. 5 is a flowchart illustrating a method of precisely aligning locations of an optical component using the precision alignment device of an optical component according to the present embodiment.

### DETAILED DESCRIPTION OF THE INVENTION

In below, the present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Also, to clearly describe, a description of regardless parts will be omitted. Through the whole specification, like reference numerals in the drawings denote like elements.

Hereinafter, detailed technical contents desired to be executed will be described in detail with clarity referring to the attached drawings.

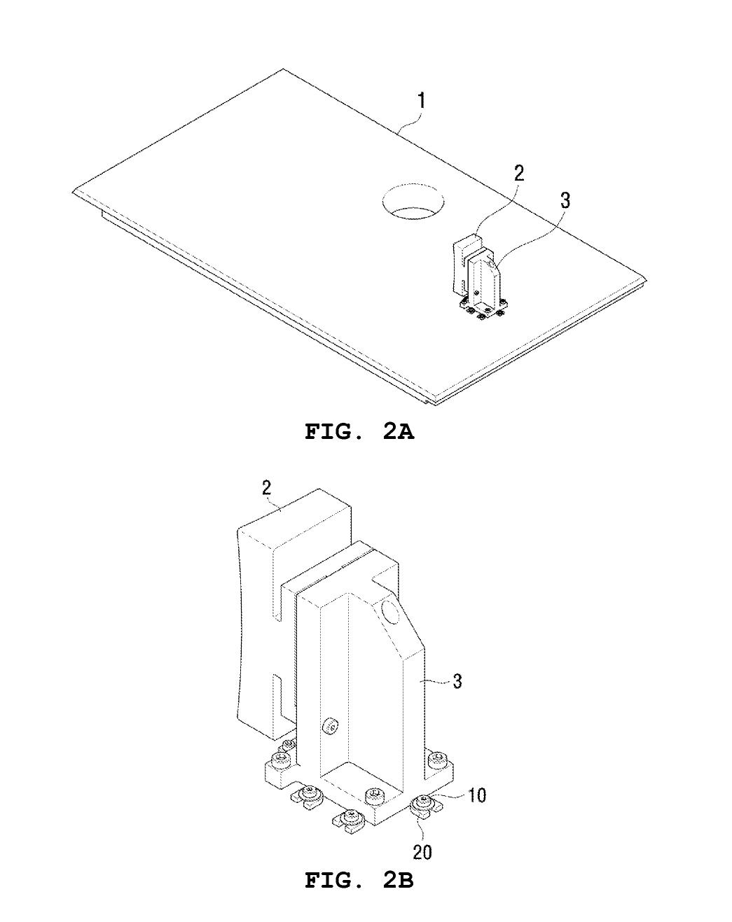

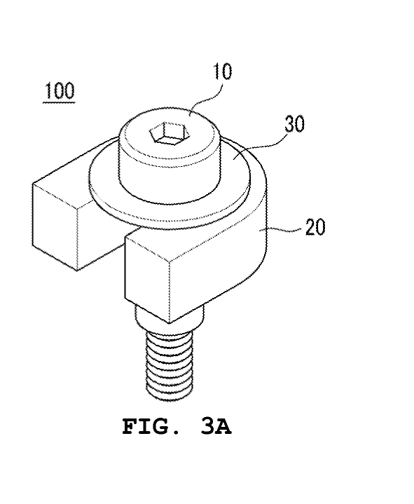

FIG. 2A is a perspective view illustrating an aspherical mirror is installed on an optical table 1 according to an embodiment of the present invention, and FIG. 2B is an enlarged view illustrating a part of the mirror in FIG. 2A.

As shown in FIGS. 2A and 2B, without installing a typical micrometer for precisely aligning optical components, it is possible to precisely align an optical component in a small space by installing a precision alignment device of an optical component according to an embodiment of the present invention.

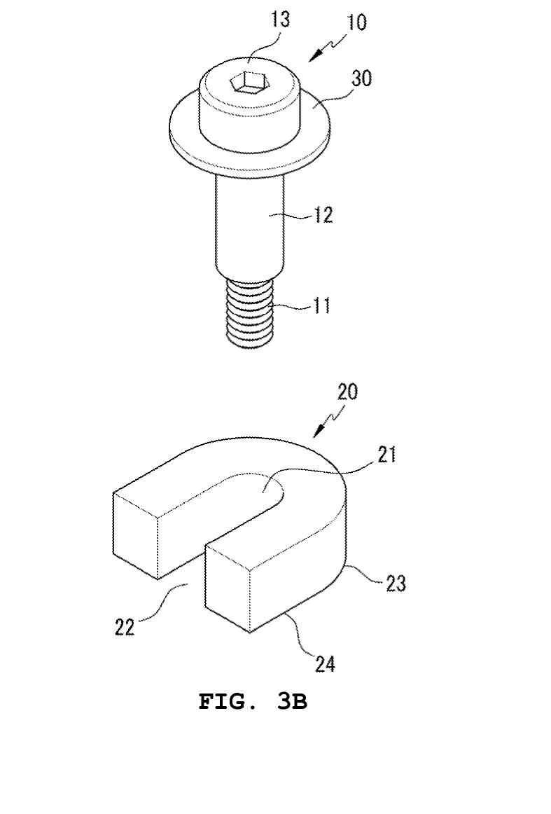

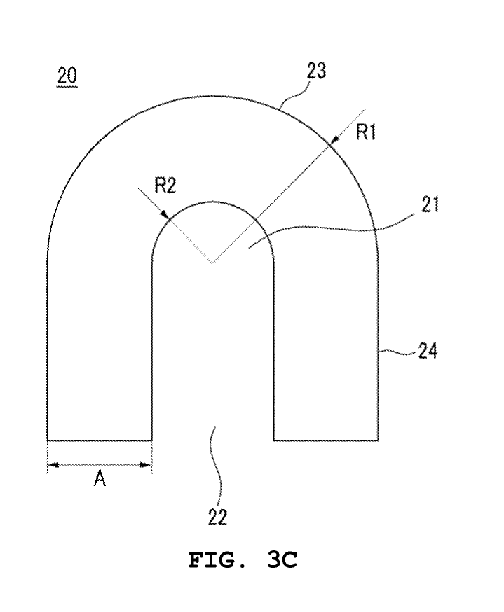

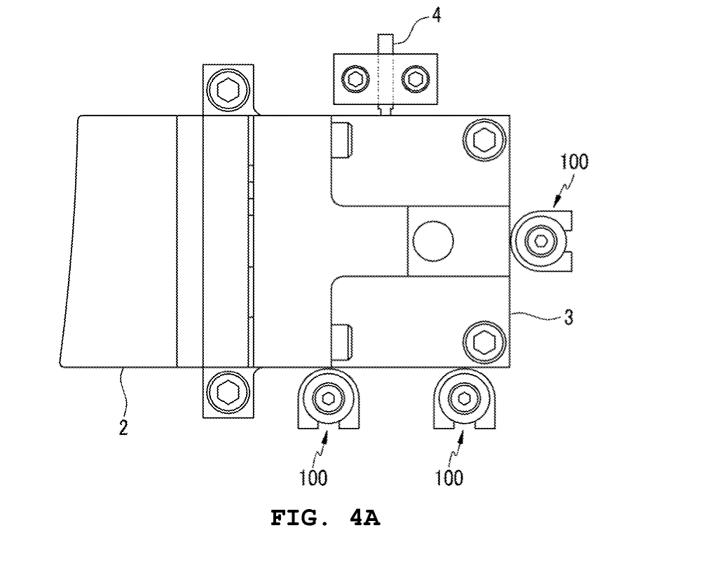

Hereinafter, the precision alignment device of an optical component according to the present embodiment will now be described in detail with reference to FIGS. 3A to 3C.

FIG. 3A is a perspective view illustrating the precision alignment device of an optical component according to the present embodiment, FIG. 3B is a perspective view illustrating a location fixing unit 10 and a bumper 20 that are components of the precision alignment device of an optical component according to the present embodiment, and FIG. 3C is a top view illustrating the bumper 20 according to the present embodiment.

As shown in FIGS. 3A and 3B, the device 10 mainly includes the location fixing unit 10 and the bumper 20, and may further include a washer 30.

The location fixing unit 10 is inserted into a pin hole formed on the optical table 1 and coupled thereto and closely attached to an optical mount 3 fixing the optical component 2 such as a mirror, a lens, and a prism, and fixes a location of the optical component 2.

The location fixing unit 10 includes a screw portion 11 inserted into the pin hole formed on the optical table 1 and fastened and coupled thereto and a head portion 13 coupled with a screw driver or a wrench to transfer a rotational force to the screw portion 11 and may further include a non-screw portion 12.

The non-screw portion 12 is located between the head portion 13 at a top end and the screw portion 11 at a bottom end and formed of a smooth surface where there is no formed a screw thread, different from the screw portion 11, in such a way that a location of the optical mount 3 can be more precisely determined by coupling the bumper 20 to the non-screw portion 12 in the location fixing unit 10 while determining the location of the optical mount 3. In other words, when the bumper 20 is coupled to the screw portion 11 instead of the non-screw portion 12 to determine the location of the optical mount 3, there is a difficulty to determine a precise location with μm unit between the location fixing unit 10 and the optical mount 3 due to the height of a plurality of screw-crests.

The bumper 20 includes a penetration hole 21 formed to allow the location fixing unit 10 to penetrate therethrough, the penetration hole 21 having a certain thickness in a lateral direction to maintain a certain distance between the location fixing unit 10 and the optical mount 3 when the optical mount 3 is closely attached to at least one side surface thereof.

When the bumper 20 is coupled with the location fixing unit 10, the location fixing unit 10 functions as a fixing pin for precisely aligning the location of the optical mount 3 due to the thickness of the bumper 20 formed in a lateral direction.

That is, the precision alignment device of an optical component includes a plurality of the bumpers 20 having various thicknesses formed being precisely processed in a lateral direction and one or more pairs of the location fixing units 10 and the bumpers 20 fastened to the location fixing unit 10 as shown in FIG. 2B are arranged on a side of the optical mount 3, thereby precisely aligning the location of the optical mount 3.

The thickness formed being precisely processed in a lateral direction, as an example as shown in FIG. 3C, may be uniform at between an outer surface and an inner surface where the location fixing unit 10 is inserted into. A curved portion 23 of the bumper 20 may be provided to have a uniform difference between an outer diameter R1 and an inner diameter R2, and a flat portion of the bumper 20 may be provided to have a uniform thickness A that is a distance between the outer surface and the inner surface through the entire bumper 20. This is because the location of the optical mount 3 should not be changed depending on a location of the bumper 20 where the location fixing unit 10 is inserted into.

As an example of precisely aligning the location of the optical mount 3, as shown in FIG. 2B, there are provided three pairs of the location fixing units 10 and the bumpers 20 formed being precisely processed to have a uniform thickness in which one pair of the location fixing unit 10 and the bumper 20 is on one side of the optical mount 3 and two pairs are arranged on a surface adjacent thereto, the adjacent surface being orthogonal to the side, to perform as fixing pins, thereby precisely aligning the optical mount 3.

Also, the bumper 20, as shown in FIG. 3C, may further include an opening 22 formed on one side thereof from the side to the penetration hole 21 to allow the location fixing unit 10 to be inserted and coupled thereto.

The bumper 20 further including the opening 22 on the one side to be formed as an open-type, thereby more reducing abrasion of the pin hole formed on the optical table 1 due to repetitive use than a closed-type bump.

That is, after the location fixing unit 10 penetrates the penetration hole 21 of the bumper 20 and coupled and fastened to the pin hole formed on the optical table 1, when the bumper 20 is formed as a closed-type and should be replaced by another one with a different size and a different shape, the location fixing unit 10 is repeatedly fastened to or released from the pin hole formed on the optical table 1, thereby causing the abrasion of the pin hole. However, when the bumper 20 is formed as an open-type, without repeatedly fastening and releasing the location fixing unit 10 to and from the pin hole, the location fixing unit 10 is inserted into or released from the bumper 20 via the opening 22, thereby preventing the abrasion of the pin hole.

Also, the bumper 20, as shown in FIG. 3, may further include flat portion 24 formed by extending the opening 22 in a certain direction.

The flat portion 24 is formed on the adjacent surface orthogonal to the one side where the opening 22 is formed, thereby the bumper 20 is formed as an open-type including the opening 22.

In this case, the optical mount 3 may be not moved by the bumper 20 in a process of transferring the bumper 20 along the one side of the optical mount 3 to separate the location fixing unit 10 from the bumper 20 via the opening to insert or release the location fastening unit 10 into or from the bumper 20 via the opening 22.

Also, the bumper 20, as shown in FIG. 3C, may further include the curved portion 23 roundly formed on one side with a certain curvature.

The curved portion 23 is formed on a portion of the outer surface, that is, on one side of the bumper 20 in such a way that the bumper 20 can be easily coupled to or released from the location fixing unit 10 coupled and fastened to the pin hole formed on the optical table 1 when the bumper 20 is formed as the open-type including the opening 22.

In other words, one side surface of the outer surface of the bumper 20 is formed roundly with a certain curvature in such a way that a tangent of the outer surface formed roundly is identical to the one side of the optical mount 3, thereby preventing a transfer of the optical mount 3 caused by the bumper 20 while separating the bumper 20 by rotating on the location fixing unit 10 to couple or release the bumper 20 to or from the location fixing unit 10.

The washer 30 is located between the head portion 13 of the location fixing unit 10 and the bumper 20, the washer 30 with a penetration hole to allow the location fixing unit 10 to penetrate the washer 30.

As the washer 30, there may be various kinds of washers such as a flat washer and a spring washer. The washer 30 is located between the location fixing unit 10 and the bumper 20 to protect the surface of the bumper 20 and improve a coupling effect of the head portion 13 of the location fixing unit 10 and the bumper 20 to fasten the location of the bumper 20 while coupling the head portion 13 of the location fixing unit 10 to the bumper 20.

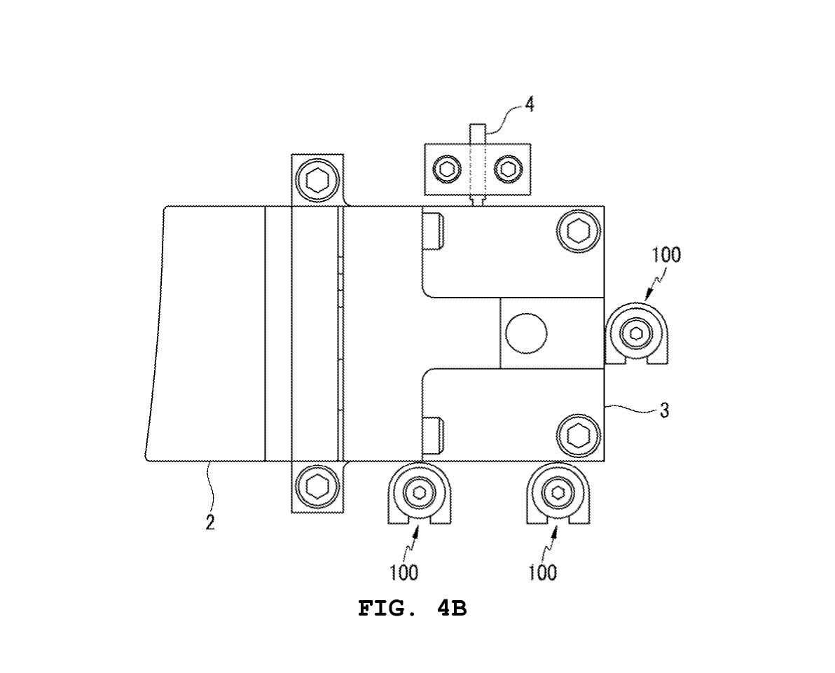

Hereinafter, there will be described an example of aligning the location of the optical mount 3 by using the precision alignment device of an optical component according to the present embodiment with reference to FIGS. 4A and 4B.

FIGS. 4A and 4B are top views illustrating the example of aligning the location of an optical mount 3 by using the precision alignment device of an optical component according to the present embodiment.

As shown in FIGS. 4A and 4B, grouping the three devices 100 as one set, two devices 100 are located on the one side of the optical mount 3 and one device 100 is located on an adjacent surface orthogonal to the one side of the optical mount 3.

Also, on a surface opposite to the one side of the optical mount 3 where the device 100 is located, as shown in FIGS. 4A and 4B, a set screw 4 may be located (another set screw is located on a bottom of the optical component 2 and not shown).

Three precision alignment device of an optical component 100 are located on the periphery of the optical mount 3 in such a way that a tangent of the curved portion 23 roundly formed with a certain curvature is identical to one surface of the optical mount 3, thereby allowing the devices 100 to function as fixing pins for fixing the location of the optical mount 3. When the three devices 100 form one set as described above, the location of the optical mount 3 can be fully, precisely aligned. When further providing four or more devices 100, it becomes an over-constraint state in which constraint conditions are excessively applied, which is not preferable.

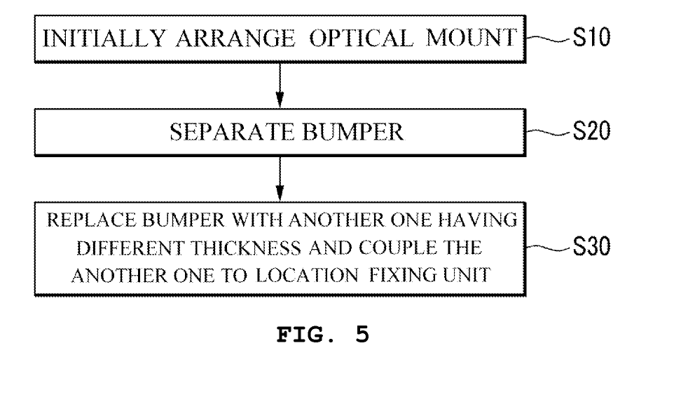

Hereinafter, there will be described a method of precisely aligning an optical component by using the precision alignment device of an optical component according to the present embodiment with reference to FIGS. 4A, 4B, and 5.

FIG. 5 is a flowchart illustrating the method of precisely aligning an optical component by using the precision alignment device of an optical component.

The method, as shown in FIG. 5, includes transferring the optical mount 3 to be closely attached to the precision alignment device of an optical component 100 inserted and coupled to the pin hole of the optical table 1 to be initially arranged (S10), separating the bumper 20 having a thickness in a lateral direction, from the location fixing unit 10 (S20), and coupling another bumper having a thickness different from that of the bumper 20 with the location fixing unit 10 (S30).

That is, as shown in FIG. 4A, a location of the optical mount 3 is determined by arranging at least one set screw 4 on a side of the optical mount 3 and arranging at least one precision alignment device of an optical component 100, thereby initially arranging the location of the optical mount 3 (S10).

After the initially arranging, when a direction and a distance of transferring the optical mount 3 initially arranged with respect to the optical component 2 fixed by the optical mount 3 is determined via an initial arrangement test, as shown in FIG. 4B, the set screw 4 is released and the location fixing unit 10 is released at a minimum, then a direction of the bumper 20 is rotated, and the bumper 20 is pushed and separated to allow the location fixing unit 10 to be out of the bumper 20 via the opening 22 (S20).

In this case, the bumper 20 is rotated along the curved portion 23 roundly formed with a certain curvature on one side of the outer surface of the bumper 20 and is pushed along the flat portion 24 connected to both ends of the curved portion 23 to allow the location fixing unit 10 to be out of the bumper 20 via the opening 22, thereby separating the bumper 20 from the location fixing unit 10.

After that, the bumper 20 is replaced with another bumper 20 having a thickness different from the thickness in a lateral direction of the bumper 20, the another bumper 20 is coupled to the location fixing unit according to a reverse order of the separation described above, and the set screw 4 is also fixed, thereby precisely aligning the location of the optical mount 3 (S30).

As described above, the method of precisely aligning the optical component 2 or the optical mount 3 by using the precision alignment device of an optical component 100 provides effects of precisely aligning an optical component in a small space due to a simple configuration and easy installation and being hardly disordered or malfunctioning after a long time use because a typical micrometer is not used.

The precision alignment device of an optical component and the method of precisely aligning an optical component by using the device provide an effect of precisely aligning an optical component in a small space since a configuration is simple and an installation thereof is easy.

Also, precision alignment device of an optical component and the method of precisely aligning an optical component by using the device provide an effect of preventing an additional expense that may occur when a typical micrometer is applied to an optical apparatus operated in a vacuum container at an extremely low temperature.

Also, the precision alignment device of an optical component and the method of precisely aligning an optical component by using the device provide an effect in which there is little possibility of being disordered or malfunctioning after the device is used for a long time because there is not needed a manual or electrical driving device required in an alignment method using a typical micrometer.

Also, the precision alignment device of an optical component and the method of precisely aligning an optical component by using the device employ an open-type bumper, thereby more reducing abrasion of a pin hole formed on an optical table caused by repetitive use than a case of employing a closed-type bumper.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A precision alignment device of an optical component, the device comprising:
a location fixing unit inserted and coupled to a pin hole on an optical table, closely attached to an optical mount, and fixes a location of the optical component; and
a bumper comprising a penetration hole formed to allow the location fixing unit to penetrate to be coupled thereto, the bumper having a thickness formed in a lateral direction to maintain a certain distance between the location fixing unit and the optical mount when at least one side is closely attached to the optical mount,
wherein a location of the optical mount is determined while coupling the bumper with the location fixing unit.

2. The device of claim 1, wherein the location fixing unit comprises a non-screw portion where there is not formed a screw thread, and
wherein the bumper is coupled to the non-screw portion and determines the location of the optical mount.

3. The device of claim 1, wherein the bumper comprises an opening formed on one side thereof from the one side to the penetration hole to allow the location fixing unit to be inserted and coupled thereto.

4. The device of claim 3, wherein the bumper further comprises a flat portion on the one side formed by extending the opening in a certain direction.

5. The device of claim 1, wherein the bumper comprises a curved portion formed roundly with a certain curvature on one side.

6. The device of claim 1, further comprising a washer located between a head portion of the location fixing unit and the bumper, the washer with a penetration hole to allow the location fixing unit to penetrate the same.

7. A method of precisely aligning an optical component by using the device according to claims 1, the method comprising:
transferring an optical mount to be closely attached to the device inserted and coupled to a pin hole of an optical table to be initially arranged;
separating a bumper having a thickness in a lateral direction, from a location fixing unit; and
coupling another bumper having a thickness different from that of the bumper having a thickness in a lateral direction, to the location fixing unit.
